(19) United States
(12) Patent Application Publication
(10) Pub. No.: US 2004/0009762 A1
(43) Pub. Date: Jan. 15, 2004

(54) Dynamic pricing and yield management in mobile communications

(76) Inventors: Stefan Bugiu, Bucharest (RO); Adrian Amariei, Cambridge, MA (US); Ion Leon Batachia, Bucharest (RO)

Correspondence Address: MINTZ LEVIN COHN FERRIS GLOVSKY & POPEO, 666 THIRD AVENUE, NEW YORK, NY, 10017, US

(21) Appl. No.: 10/447,345

(22) Filed: May 28, 2003

Related U.S. Application Data
(60) Provisional application No. 60/383,723, filed on May 28, 2002.

(51) Int. Cl. H04M 11/00

(52) U.S. Cl. 455/406; 455/405

(57) ABSTRACT

A method and system for promoting utilization of one or more customer accounts of a communications provider and may include extracting customer information from a billing support system of a communications provider and selecting one or more customer accounts for offering an incentive to a corresponding account holder of the one or more customer accounts to use the account. The one or more customer accounts are selected based upon at least one of one or more personal details and one or more details obtained from call data records of the customer accounts and the personal information may be obtained from the customer information from the billing support system. The method and system may also include notifying the corresponding account holders of the one or more customer accounts of the incentive substantially in real-time.

### CLAIM TO PRIORITY

The present invention claims priority to U.S. provisional application No. 60/383,723, filed May 28, 2002, the entire disclosure of which is herein incorporated by reference.

### FIELD OF THE INVENTION

The invention is related to methods and systems for the telecommunications (telecom) industry, and more particularly to methods and systems for selectively promoting the use of a communications network and/or one or more customer accounts of a telecom provider, especially during low utilization periods of a communications network.

### BACKGROUND OF THE INVENTION

Nearly every, if not all, telecom providers, especially wireless telecom providers, need to balance demand with network capacity. In extreme situations, the providers must do this with network congestion during peak hours, and little to no usage at other times. For some providers, this results in a substantial amount of airtime that goes unsold. The high costs of operating and upgrading wireless communication networks, combined with reduced investment, has lead to the need for telecom providers to maximize revenues from subscribers (customers) to increase profitability.

Moreover, customers of providers have become more sophisticated and demand value and high quality of service. Customers are aware of the total cost of ownership of their mobile (wireless) service and if they believe they are not getting the right service at the right price, they are inclined to leave and go to another provider (churn). As time goes by, legislation and market forces will make it easier for customers to leave their existing service provider (e.g., no more one-year contracts). Thus, providers need to address customer concerns.

A major contributor to customers leaving one provider for another is price. Most providers find that it is usually of little value trying to match a competitor's offer for services after the customer has decided to change providers. Price is a complex issue for customers—providers have created various package deals, special rating plans, and variable discounts to try to meet the needs of many customers. However, most customers often find the task of comparing the plans of various providers daunting. This may result in customer alienation, making it harder to retain and grow market share and customers making decisions based on perception rather than reality.

Thus, one of the major problems facing providers today is retaining customers (i.e., preventing customer churn). Primary to that problem is providers inability to respond quickly and effectively to competitor initiatives. This is mainly because the time and effort required to target and implement new pricing plans is time consuming and requires the efforts of skilled resources. The market average for implementing a new pricing plan currently ranges anywhere from weeks (e.g., 3-4) to months. For some customers, this is far too long.

Accordingly, a system and method is needed to quickly and efficiently create and implement new pricing plans, discounts, and or incentives, and communicate such offers immediately to customers. Such a need coupled with low utilization of network capacity are issues which require the prompt attention by telecom providers.

### SUMMARY OF THE INVENTION

Accordingly, the present invention sets forth methods and systems to selectively promote, preferably on a real-time basis, the use of a telecom network and/or one or more customer accounts of a particular telecom provider. This promotion of the network and/or provider may be made during low utilization periods of the communications network, either predicted or unpredicted, with regard to the entire network or just certain portions (e.g., cell sites) thereof. Accordingly, customers may be rewarded by being offered with discounts and/or incentives (promotions) to use their accounts, and/or by being offered promotions for having used their accounts (e.g., rewarding good customers). Such promotions may reduce customer chum and/or maximize revenue for a provider.

To that end, in some embodiments of the present invention, negotiation between pricing and usage behavior through instant promotions may be used to improve customer retention. Some embodiments of the present invention encourage positive changes in usage patterns (e.g., micro-segmentation of usage behavior) of customers through the use of promotions, which results in the provider realizing revenues for under utilized network capacity (for example). The selection of customers to receive promotions may be based upon predetermined criteria (e.g., business rules, customer usage/personal profiles and/or other criteria).

Some embodiments of the present invention provide a system, which may be independent of a provider's billing system, to provide the promotion(s) to customers. Thus, a provider need not modify their existing system configuration(s). Moreover, some embodiments may enable providers to identify those customers (e.g., profiling) that the provider is most at risk of losing and then offering them (e.g., in real-time) promotions that are designed to create the right perception of price with the customer. In still other embodiments, customers who have spent a predetermined amount of money with the provider may be rewarded through such promotions.

In one embodiment of the present invention, a method for promoting usage of a customer account of a communications provider may include identifying one or more customer accounts of the communications provider for providing an incentive to an account holder of the one or more customer accounts to use the corresponding account, determining an incentive for enticing the account holder of the customer account to use the account and notifying the account holder substantially in real-time of the incentive.

In another embodiment of the present invention, a method for promoting utilization of unused network capacity in a communications system may include identifying a low usage period of network activity of a communications network, identifying one or more customer accounts within the communications network for offering an incentive to a corresponding account holder of the one or more customer accounts to make use of the low activity period and notifying an account holder of the one or more customer accounts of the incentive substantially in real-time.

In yet another embodiment of the present invention, a system for promoting usage of a customer account of a communications provider may include identifying means for one or more customer accounts of the communications provider for providing an incentive to a corresponding account holder of the one or more customer accounts, determining means for determining an incentive for enticing the account holder of the customer account to use the account and notifying means for notifying the account holder substantially in real-time of the incentive.

In still another embodiment of the present invention, a system for promoting utilization of unused network capacity in a communications system may include first identifying means for identifying a low usage period of network activity of a communications network, second identifying means for identifying one or more customer accounts of a communications provider who are located within the portion of the communications network experiencing the low usage and notifying means for notifying a corresponding account holder of the one or more customer accounts of an incentive to use the account substantially in real-time.

In another embodiment of the present invention, a server in communications with a communications network may be provided. The server may be used for promoting usage of one or more customer accounts of a communications provider. The server may include one or more processors for identifying one or more customer accounts of the communications provider for providing an incentive to a corresponding account holder of the one or more customer accounts to use the account. The one or more processors may also be used for determining an incentive for enticing the account holder to use the account. The server may also include communication means for notifying the account holder substantially in real-time of the incentive.

In yet another embodiment of the present invention, a system for promoting utilization of a communications system may include a communications network, a customer relations management system and a billing support system (BSS) for managing billing to the one or more customers. The BSS may include a customer database for storing customer information of the one or more customers, where the customer information includes call details of calls of the one or more customers. The system may also include a mediation system for collecting call detail information from the communications network, where the call detail information is forwarded to the BSS and an incentive determining system including a lifestyle database. The incentive determining system may select one or more customer accounts for receiving an incentive to a corresponding account holder of the one or more customer accounts for utilizing the account. The system may further include an instant messaging service for notifying the selected one or more customers determined to receive the incentive.

In another embodiment of the present invention, a method for promoting utilization of a customer account of a communications provider may include extracting customer information from a billing support system of a communications provider and selecting one or more customer accounts for offering an incentive to a corresponding account holder of the one or more customer accounts to use the account. The one or more customer accounts are selected based upon at least one of one or more personal details and one or more details obtained from call data records of the customer accounts. Personal information may be obtained from the customer information from the billing support system. The method may also include notifying the respective account holders of the one or more customer accounts of the incentive substantially in real-time.

The invention may also include computer readable media embodiments for performing one or more of the methods outlined in the above embodiments. The invention may also further include computer application program embodiments for enabling a computer system to perform one or more of the method embodiments. p These aspects and advantages of the invention will become even more clearer with reference to the drawings, a brief description of which is set out below, and detailed description which follows.

### BRIEF DESCRIPTION OF THE DRAWINGS

FIG. 1 is block diagram illustrating an overview a system according to an embodiment of the present invention.

FIG. 2 is a block diagram illustrating an overview of a pre-paid system according to an embodiment of the present invention.

FIG. 3 is a block diagram illustrating an overview of components of the post-paid system for an embodiment of the present invention involved with obtaining data from a communications provider using log files, for example.

FIG. 4A is a flow diagram illustrating an overview of a process that may be used by a telecom to provide and process promotional offers to a market segment according to an embodiment of the present invention.

FIG. 4B is a table illustrated example methods of providing an offer incentive to a billing system of a telecom according an embodiment of the present invention.

FIG. 4C is a flow diagram illustrating an overview of a segmentation flow according to an embodiment of the present invention.

FIG. 5A is a flow diagram illustrating an overview of a process for creating an offer to present to a one or more customers of a telecom provider according to an embodiment of the present invention.

FIG. 5B is a flow diagram illustrating an overview a sub-flow of one of the steps of the flow diagram of FIG. 5A according to an embodiment of the present invention.

FIGS. 6-31 illustrate various screenshots of a graphical user interface for an application program for conducting one or more processes according to some embodiments of the present invention.

FIG. 32 is a table illustrating general market and subscriber (customer) assumptions in the telecom market.

FIG. 33 is a table illustrating marketing assumptions for revenue increases associated with embodiments of the present invention as they are applied to the telecom industry.

### DETAILED DESCRIPTION OF THE PREFERRED EMBODIMENTS

It is understood that embodiments of the present invention may be carried out by various means including computing devices (servers, personal computers, mainframes, minicomputers, super computers and the like), as well as their associated peripheral devices, and other devices to which such computer devices communicate with. To that end, such computing devices generally includes one or more processors for operating software, which thus may be used for carrying out one or more methods of the present invention. Moreover, such computer devices include RAM and ROM memory, hard drives, CD burners, flash memory, printers, input devices (keyboard, mouse, trackpad, microphone), sound devices (sound card, loudspeakers), networking devices (e.g., Ethernet), and/or any other system, software and device that one of ordinary skill in the art would understand as being required to carry out the methods and systems of the present invention.

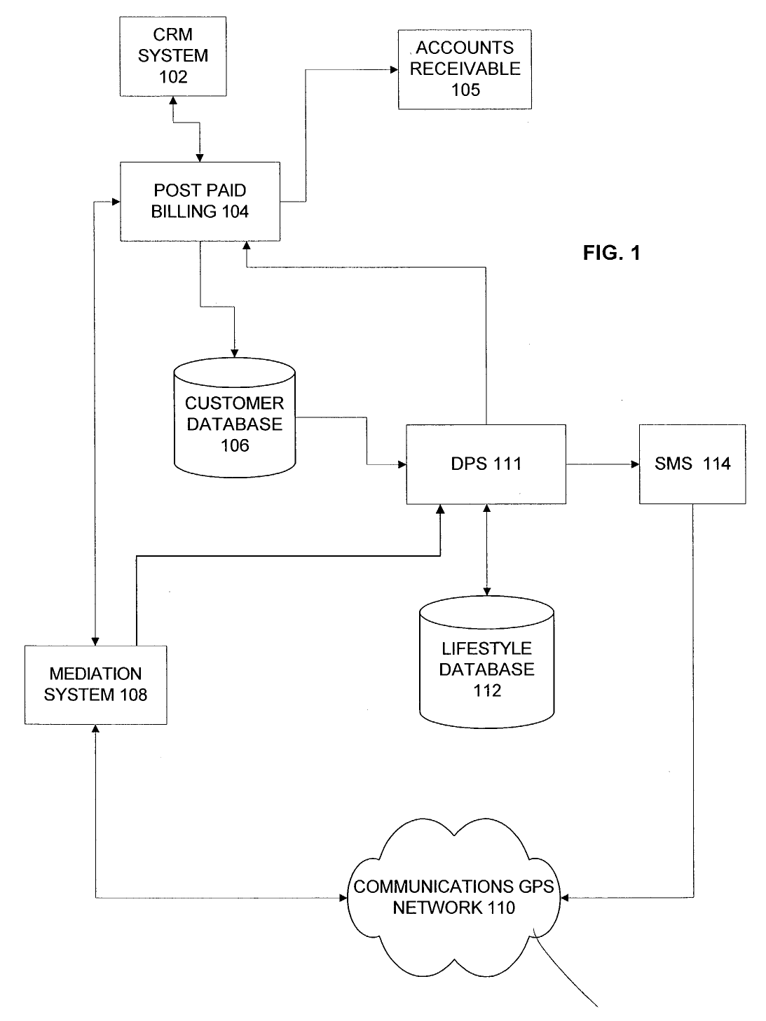

FIG. 1 represents a block diagram of a system according to some embodiments of the present invention. Although the embodiments of the present invention are illustrated with reference to a mobile telecom (e.g., wireless) system and providers of such services (including voice, data, fax, GPRS, WAP and/or SMS; anything that may provide a Call Data Record), one of skill in the art will recognize that embodiments of the present invention may be equally applicable to any communications network (e.g., land-line). Accordingly, a customer relation management system 102 may coordinate with a postpaid billing system 104, which includes a customer database 106. The customer database may include information regarding account holders (i.e., customers), which may include customer details and personal information (e.g., phone number, name, address, age, sex, occupation, and the like) and/or Call Detail Records (CDRs) of activity performed (such as calls, data transfers, GPRS usage, SMS sending, MMS sending, WAP data transfer, and any other activity that produces CDRs) by customers. Such information may be forwarded to an accounts receivable system 105, which forwards invoices to the customer.

A mediation system 108 directs CDRs from a communications network 110 to the post-paid billing system. This information is used to determine the amount of airtime and other details about calls placed by a corresponding customer. A Dynamic Promotion System (DPS) 111 may collect customer account information from the post-paid billing system and store such information in a lifestyle database 112, as well as collect and store CDRs directly (or indirectly) from the mediation system (108), in the lifestyle database as well (which may be accomplished in real-time, for example). Using the lifestyle database, the DPS system may then select customer accounts to receive promotions (e.g., offers for a discount of usage of a customer's account). The promotions may be made during periods of airtime of the network which have been either concurrently or previously determined to be under utilized. These offers may be communicated to account holders (customers) of the selected customer accounts via a SMS 114.

The customer account information contained in the customer database and which may be stored in the lifestyle database 112 may include: account/phone number, name, address, post/zip code, category(s) or class of customer, products, services, arrears action (including date), free minutes, rate plane, billing day, and other user definable fields (e.g., age, sex, etc.). Still other information of the customer may include employment information (employer, years of service, etc.), eye color, birth date, hair color, weight and/or any other personal information collected from the customer at one time or another through any applicable means. Such information may be grouped in the lifestyle database to provide efficient searches for segmentation—i.e., targeting of certain customers to receive a promotion.

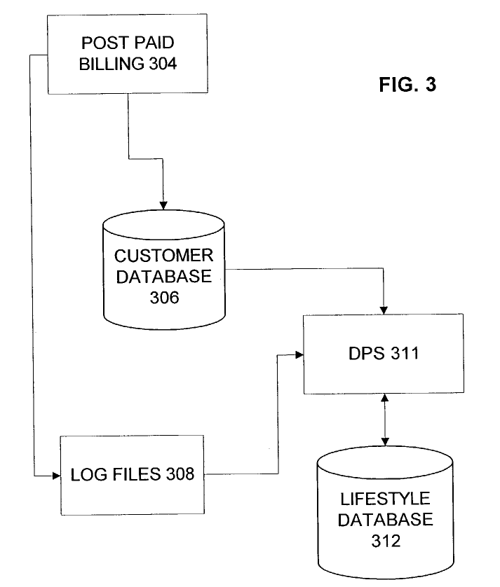

The extraction of customer information from the provider customer database may be accomplished using one or more extraction programs (which may be configurable). As shown in FIG. 3, such information may also be extracted from log files 308, associated with the post paid billing system 304 (including customer database 306). The extraction program may then interface, via a standard application-program-interface (API), with a loading application for loading the extracted customer information into the lifestyle database 312 of the DPS system 311. The loading of the customer information into the lifestyle database may include loading call detail information into usage tables (see below).

Data extraction from the databases may be accomplished so that preferably, it obtains the most current data during a time of day at which network activity is low (e.g., night). Accordingly, the customer information may be extracted in real-time or in a batch process, for example, from an active database overnight. Preferably, extraction may be a “read-only” operation. Alternatively, the customer data may be extracted from a copy of the customer database, which providers typically have on hand for back up, disaster recovery and/or testing purposes. As stated before, embodiments of the present invention may also obtain customer data from log files used to update the provider customer database. If such log files are used, the following information may be obtained therefrom: rated calls by account/phone number, changes to previously rated calls, new customer details, closed and/or terminated accounts.

The extracted customer information may be loaded into the lifestyle database via a loading application, for example. The loading application may take all CDRs and post them, for example, to usage tables in the lifestyle database that may later be used to provide details of call patterns by number, geographic calling area, and the like (for example). The call patterns may also be used to create a promotion or to determine which customers get a promotion.

In some embodiments of the present invention, information of the customers for the lifestyle database may be obtained via website data input (registration), for example. Customers may be invited to signup (for example) to be apart of a promotion program (e.g., incentive targeting) and may input various personal information which may include: phone numbers of family and friends (may usually apply where the provider billing system does not support such numbers or restricts the number of phone numbers a customer may select), countries where discount calls would be of interest, times and days when discount calls would be of interest, and times when it would be convenient to receive messages. The customer information gathered from the website may also be used to validate customer information obtained from the provider's customer database. Website registration may be a preferable way to obtain many personal details for the segmentation process. Such personal information allows the pinpoint segmentation of select groups of people to receive promotions.

Another method of obtaining additional personal information from customers may be through messaging (e.g., instant messaging), which may be coupled with a promotion to create an incentive for the customer to give such information. This is especially relevant for pre-paid customers, where the telecom provider does not usually track usually a great deal of information (or none at all) about the customer, or a longtime postpaid customer, e.g., whose lifestyle/interests may now be different than when the customer first obtained the service (originally a student now a business professional). In such circumstances, a message/promotion may be sent, for example, as follows: “All calls in the next hour are 50% less if you input your profession or go to our website and answer a questionnaire.”

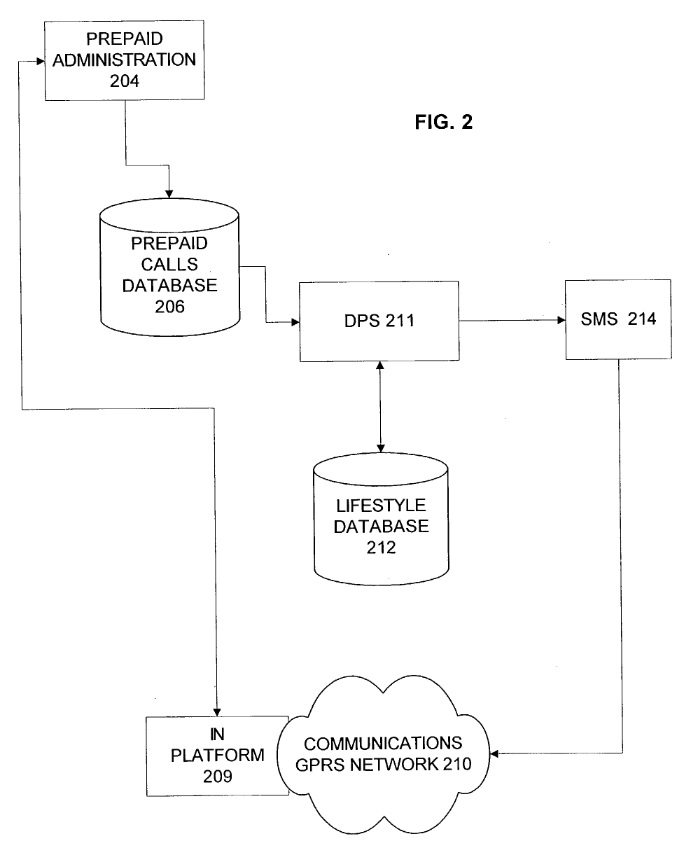

Some embodiments of the present invention may also be applicable to pre-paid customer accounts (accounts in which account holders pre-pay for airtime). As shown in FIG. 2, CDRs for calls made from customer accounts from the communications network 210 (“in platform” 209) may be forwarded to a pre-paid administration system 204, which stores the information in a pre-paid call database 206. The administration system may also provide this information as well as information regarding prepaid funds available for each customer account to the DPS system 211, which stores the information in the lifestyle database 212. Since (typically) prepaid customer details are not usually captured (or very little information is captured), and since there may be no requirement from the provider for billing information for prepaid accounts, the administration system may only retain the CDRs of a predetermined number of previous calls (e.g., 10-12 calls) of the prepaid customer accounts. Accordingly, the DPS system may use this information to determine which pre-paid customers will receive discounts (e.g., usage tables). Data for pre-paid customers may include: phone number, handset type/model, services, and other user definable fields (e.g., age, sex, and the like), if provided by the customer at some point. The prepaid account information may be uploaded to the DPS system on a recurring basis (e.g., once or several times a day) or in real-time. Prepaid customers may also be invited to register with the promotion and provide personal information for the segmentation process via website registration. Prepaid customers are made aware of promotional offers via, for example, SMS system 214.

A promotion for embodiments of the present invention may be any incentive, discount or advantage applied to a customer account for the account holder. A length of a promotion may be an allocated time period, defined by a starting time and an ending time, for which the particular promotion (or group of promotions) will apply (i.e., the discount will be offered). A promotion may include a percentage off a specific rate for a portion (or all) of the duration of a call, a reduced amount for calls over a certain duration, cash back, loyalty program, merchandise and the like.

The selection of customers, which may be referred to “segmentation” in the present invention, refers to specifying a group of customers to receive one or more promotions. Such segmentation may be made dynamically and preferably uses the most up-to-date information obtained from the telecom provider (or website). The criteria used to select customers (i.e., a market segment/niche) may include any imaginable criteria to pinpoint a select group including name, address, birth date, usage patterns, eye color, hair color, weight, height, profession, age, employer, address, work address, favorite color, favorite number, phone number, home phone number, mother's maiden name, schools attended, and the like.

Usage patterns derived from CDRs are of particular importance in the present invention. As previously stated, such patterns may be used to select customers to receive a promotion. For example, CDRs may be grouped in the lifestyle database according to times that calls are placed from certain customers (e.g., occupation, age), geographic areas where customers call, and the like. CDRs may also be used to determine the success or failure of a promotion.

CDR information may include length of calls, cost of the call, minimum call duration, base service (e.g. voice, fax, data), service identifier, call destinations (e.g. within network, outside the network), geographic location (by means of the cell identifier or mobile switching center identifier), time of day of calls, average duration of calls, calling party number, date of call, start and end time of call (and/or duration of call), called number and the like.

Customers may also be selected via a third-party program that creates a targeted market segment, separate and apart from the DPS system. Such third party programs may be a customer relation management system (as shown in FIG. 1), which may provide a list (file) of customers who may be on the verge of switching providers due to, for example, having not used their accounts for a period of time or in a particular manner. Such a list may also be of customers who have used the provider's services and spent, for example, a predetermined amount of money on wireless services. Such customers are selected to be rewarded for spending money on the service (for example).

Selected customers are then notified via, for example, courier, email, voicemail, and/or preferably through a real-time communications method—e.g., a phone call and/or text messaging using an instant messaging service (e.g., SMS), for example. The message sent to the customers may be customized, and cross-branded. Specifically, the messages may contain advertisements (e.g., “Coca Cola is picking up the tab”). To that end, the telecom provider may pass some or all of the cost of the call of the promotion to the advertiser.

The number of offers and timing of the promotion may be generated in any way, including randomly selected. However, the promotions are preferably offered on such occasions as to not desensitize customers—in other words, promotions should not be sent on such a basis that they will distort the regular call behavior of the customer. Said in another way, the promotions are preferably presented over various time periods in such a manner such that the customer does not get used to receiving the promotion. For example, if an offer for a particular market segment was sent every Saturday for 25% off all calls for three hours, between the hours of 3 pm and 6 pm, the market segment might only utilize that time to make calls for the entire weekend. Alternatively, such customers may begin to ignore such “regularly” provided offers.

In some embodiments of the present invention, the selection of customers may be determined during times of low usage of all or a portion of the provider's associated communications network. Such low usage time periods to receive a promotion may be coupled with criteria as disclosed above to obtain a particular set of customers to receive the incentive (e.g., via CDRs and/or other customer information). For example, the DPS system may determine that the communications network generally experiences a low usage period on Saturday mornings (or the provider operational support system may provide information to the DPS system to derive the low usage period information). Accordingly, the DPS system then would apply a business rule to select customers, for example, who may be active during that time. Thus, using the customer information, the DPS system may select customers who have young families (e.g., “soccer moms”), who would be at a soccer game, at the grocery store, and the like, who are likely up and about on Saturday mornings.

The low usage of the communications network may be limited to one or more cell sites of the providers communications network. To that end, certain criteria may select customers within the geographic area of cell sites experiencing low activity. Preferably, in some embodiments of the present invention, the identification of low usage of airtime for the communications network may be the initial step in determining whether incentives should be given to customers.

Credit for the incentive/promotion may be applied to chargeable elements of calls and may be configured to credit calls based on:

calls starting prior to the promotion period, but ending within the promotion period;

call starting and ending within the promotion period; and

calls starting within the promotion period, but ending outside the promotion period.

Since not all billing systems of telecom providers calculate free minutes (for example) on a call-by-call basis, some embodiments of the present invention may be configured to handle free call allocation by period (e.g., monthly, quarterly) and pass a credit for the eligible calls before the bill is generated (e.g., a day before the due date of the bill generation). Moreover, some embodiments of the present invention may be able to provide both methods of credits simultaneously.

In the case where a customer has free minutes based on a period and who terminates their service contract with the provider before the end of the period, some embodiments of the present invention calculate the appropriate credit based on the shortened period and post it to the account. In another example, where a call is already subject to a discount (e.g., family and friends), such credits may be excluded.

Credit information for customers for the promotion may be forwarded from the DPS to the post-paid billing system so that it may be matched up to the CDRs from the particular customer being provided the discount and applied to the customer account to generate an invoice at the end of the billing cycle. Credits may also be configured into a loyalty program, where the provider may have the choice of applying minutes to the customer account, or providing vouchers as a reward to be applied to future account balances, cash rewards, or merchandise purchases, for example.

Embodiments of the present invention may use any database management system for the lifestyle database (e.g., Oracle). Accordingly, such systems may include writing/reports tools to produce standard reports including: customer reports, call data reports and promotion reports, for example. The promotion reports may include a phone number and profile (for example) of customers targeted, the take-up of calls by customers during promotional periods, the charges produced by calls made during the promotion time period and the cost of discounts provided. A Market segment report may also be produced which may list the number of times a market segment was targeted and the response rate based on discounts offered. Usage reports may include usage patterns of customers per market segment.

The value that some embodiments of the present invention present telecom providers may be explained in the following manner as it relates to “elasticity of demand”. At the microeconomic level, the following relationships may be given to describe the optimal Ramsey prices applicable to mobile communications:

MR−MC=k(p−c)

p(1−1/e)−c=k(p−c)

=>(p−c)/p=(1/e)(1/(k−1)) (1)

where, p=price, q=quantity, e=elasticity, c=cost, k=constant, MR=marginal revenue, and MC=marginal cost.

Elasticity may be defined broadly as the resulting demand for telecom service (or anything for that matter) as reflected in an increase or decrease in the service. This allows telecom providers to better understand customers and regulatory bodies (governments), where the latter uses a system of tariffs for antitrust considerations.

Telecom providers have a variety of revenue streams (for example): connection/subscription revenues; revenues from mobile-originated calls; revenue from value-added services (e.g., SMS, information services) and call termination revenue.

Competition for subscribers should ensure that the total revenues earned from customers do not exceed the total costs of serving them, including customer acquisition and a competitive rate of return on assets. Under these considerations, K may be derived and it is the same for all the services the operator produces. K represents the percent of the company added value that stays in the company. K may be the rate of the net profit (for example).

If K is set at a desired level, the price elasticities of the services may be computed. “e” may be calculated based on the dynamic offers sent to customers. From this, a temporary price change that should be charged for each service provided to each customer can be inferred. This may be done using a regression of the type:

Quantity=a*price+b,

where “a” is the elasticity determined by running this regression on historical data obtained from dynamic offers sent. “b” is a constant.

Until now, in the absence of embodiments of the present invention, there was no possibility of identifying individual, contextual elasticities of demand. Thus, the practice could not possibly mach Ramsey models. However, one can now attempt Ramsey prices as present embodiments of the invention offer the possibility of identifying individual elasticities.

This may be done in the following manner. First, performance indicators produced by the response to a certain offer targeting a certain segment of the customer base are tracked and recorded. Elasticity may be expressed in terms of minutes or in terms of number of calls. Thus, the following may be tracked:

Target_calls_duration. The system may count the number of minutes (airtime) used by the target segment during the offer. The system may then check the information in the CDRs produced by the calls of the target segment during the availability of the offer

Witness_calls_duration. In order to accurately calculate the elasticity (the variation from a normal consumption pattern) the system preferably requires input as to what a “normal” consumption is like. This consumption may be expressed in terms of minutes or number of calls made during a period equal with the duration of the offer. This information may be either: a) manual input of the marketer based on market studies and/or b) acquired by tracking the consumption of a witness segment during the availability of the offer. The witness segment may be obtained by splitting the initial, compliant with criteria segment in two (i.e., 50/50): a target segment that will receive the message announcing the offer and a witness segment that will not receive any announcement. Both target and witness segments behaviors may be tracked during the availability of the offer

To calculate the Elasticity of demand, the following formula is applied:

Elasticity of Demand=((100−Incentive)*target calls duration)/(100*witness_calls_duration).

The incentive may be expressed as “10” for a 10% discount of the normal tariff.

Two types of offers may be presented (for example): regular offers (no witness segment), and witness segment offers. To calculate elasticity in regular offers, the target_call_duration indicator may be used along with and a manual input of a reference consumption amount (minutes or calls) by the unit of time of choice. To calculate elasticity for witness segment offers, the same calculation method is used, only that this time, the consumption pattern of the witness segment is referred to as the reference. To that end, elasticities of demand may be compared across different offers (targeting the same segment) and across various segments targeted with similar offers.

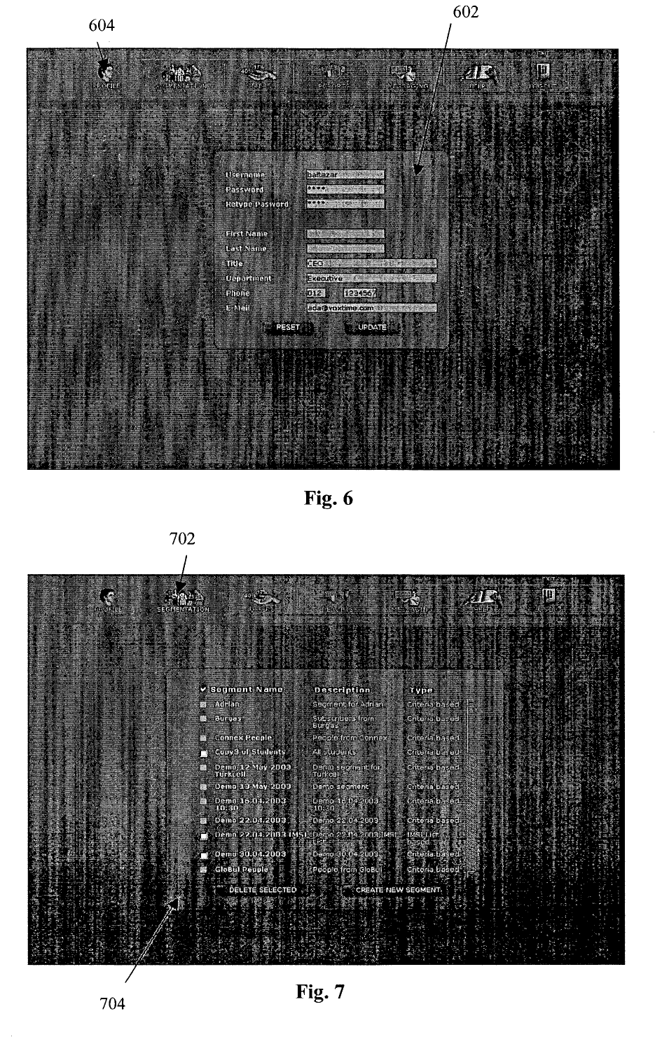

FIGS. 6-31 are screenshots of a graphical-user-interface (GUI) for a DPS application program embodiment (one such possible embodiment) for telecom providers, or entities that serve telecom providers, for creating, editing and deleting: market segments of a customer database to receive offers for discounts; incentive offers to the selected customers; reports; and messaging.

In some embodiments of the present invention, a process for making promotional offers to customer accounts may be as follows: market segmentation (selection of customer accounts) for sending a promotion and the offer to be provided in the promotion. The offer may generally be created by giving the general details of the offer, the availability periods, the incentive, Call-Data-Record filtering and the sending time of the message for informing the selected customer of the offer.

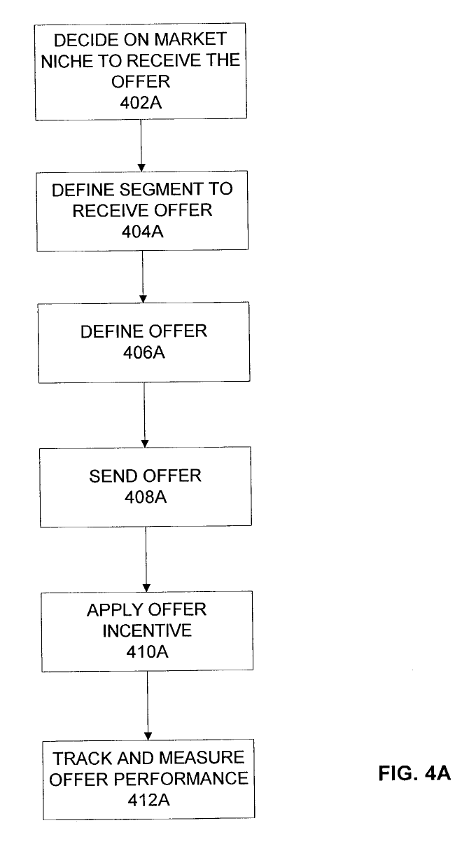

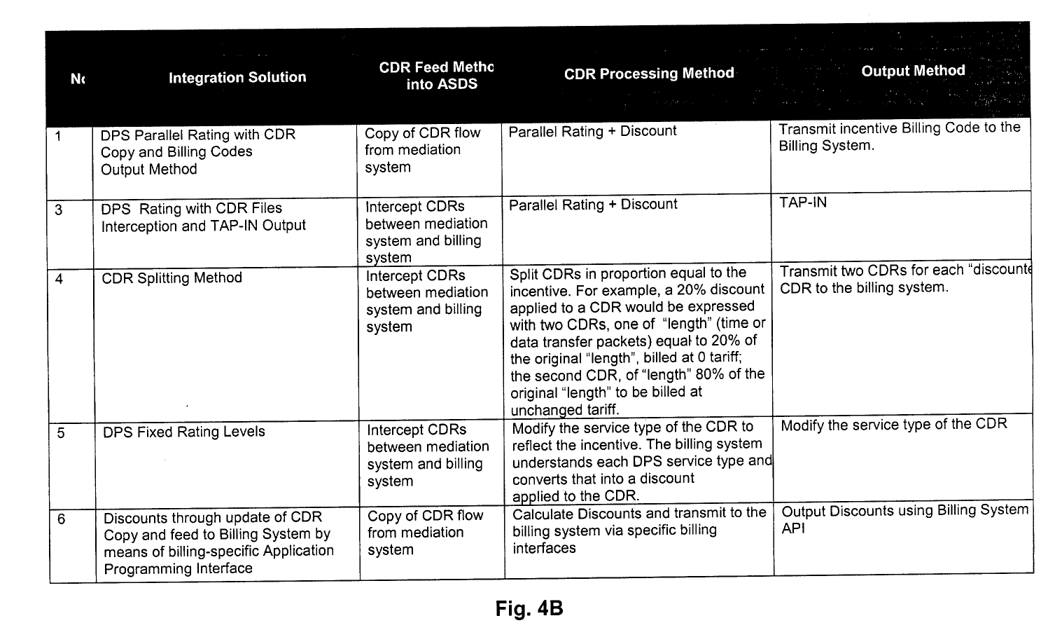

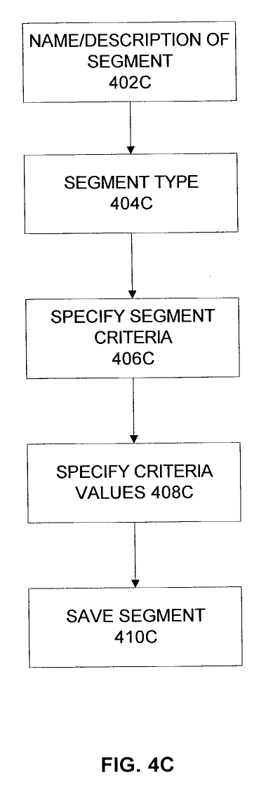

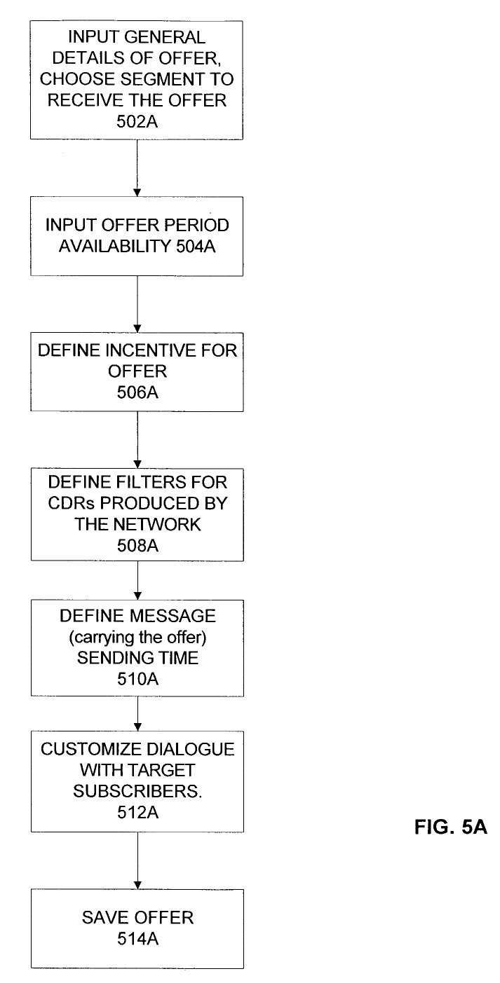

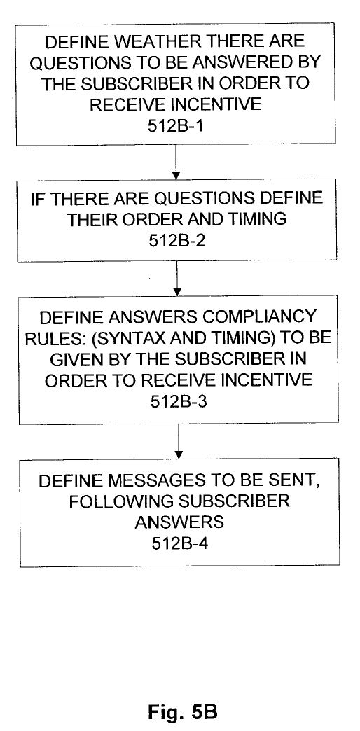

An overview of the segmentation process (targeting a select group of customers), and the creation of an offer for a market segment are illustrated in FIGS. 4A-4C, 5A and 5B, some of the specifics of which are explained with reference to the screenshots of the graphical user interface (GUI) of a DPS application of FIGS. 7-23 (below).

Accordingly, an overall process for targeting a market segment and providing promotional offers thereto is outlined in FIG. 4A. As shown, a first step may be to decide on a market niche that will receive an offer of a promotion for telecom services (402A). Thereafter, a segment may be defined according to the market niche so that applicable customers may be chosen to receive the promotional offers (404A). An offer may then be defined (406A) (or may be defined prior to the previous two steps). Once an offer has been defined, it may then be sent (408A) to the customers chosen to receive the offer (i.e., segment).

Once the offer has been received by the chosen customers, the offer incentive may be provided to the billing system (410A) of the telecom. A table illustrated in FIG. 4B provides six (6) possible methods in which the offer incentive may be provided to a billing system of a particular telecom. The method chosen may depend upon the particularities of the particular telecom's business support system (BSS).

Offer performance (i.e., how successful the offer was received and/or used by the targeted customers) may then be tracked and measured (412A), by analyzing CDRs of the targeted customers during and/or after the offer period.

A segmentation process is shown in FIG. 4C and may begin with creating a name and description of the segment (402C). A type (404C) for the new segment is selected; that is whether the segment is created by applying certain criteria to customer data, or whether the market segment is obtained from a list generated by, for example, a third party. In the case of a criteria based segment, the criteria are then specified, as well as the associated criteria values (406C-408C). The segment is then saved (410C).

With regard to the creation of the offer, as shown in FIG. 5A, general details of the offer are input (502A), including the market segment for which the offer will be sent to, followed by the input of the offer period availability (504A). An incentive for the offer is then defined (e.g., % off all calls, tariff rates or otherwise) (506A). Call-Data-Record filters may also be applied for the offer (e.g., only certain type of cell phones, calls from certain cell sites, etc.) (508A) for CDRs produced by the network. A time may be established for a message to be sent to the market segment and a message for notifying the market segment may be defined (510A). Customized dialog with targeted customers may also be defined (512A) (see FIG. 5B). After the offer has been completed, it may then be saved (514A).

With regard to customized dialog, it may be used to obtain important demographic information to be used for promotions. For example, a dialog may be initiated with targeted customers by sending a statement, like (for example), “Tell me your profession and you will receive a 45% discount (on tariff and/or other charges related to calls) on all calls in the next six hours”.

In that regard, FIG. 5B illustrates a sub-flow of the customized dialog step. Such customization may include defining whether there are any question to be answered by the targeted customer in order to receive the incentive of the offer (512B-1). If such questions do exist, then the order and timing of the questions may be defined (512B-2). Answer compliancy for the question(s) (e.g., syntax and timing) may then be defined (512B-3), to be given by the targeted customer in order to receive the offer incentive. Thereafter, messages to be sent in response to the answers returned by the targeted customers may then be defined (512B-4).

The screenshots of a DPS application program illustrate one such GUI for performing one or more of the methods of the present invention. As shown in FIG. 6, upon an administration person of a provider logging onto the system, they may be initially presented with a profile screen 602 for editing a corresponding profile of the administrator (e.g., username, password, name, title, department, phone and email). This screen may be reached by selecting the “Profile” icon 604 in the title bar area as shown in the FIG. 6.

By selecting the “Segmentation” icon 702 on the title bar, as shown in FIG. 7, a list of available (e.g., previously created) customer market segments 704 may be listed. Each of the titles of each market segment may be a link to the details of each. Thus, selecting the title, enables the details of the particular market segment to be displayed.

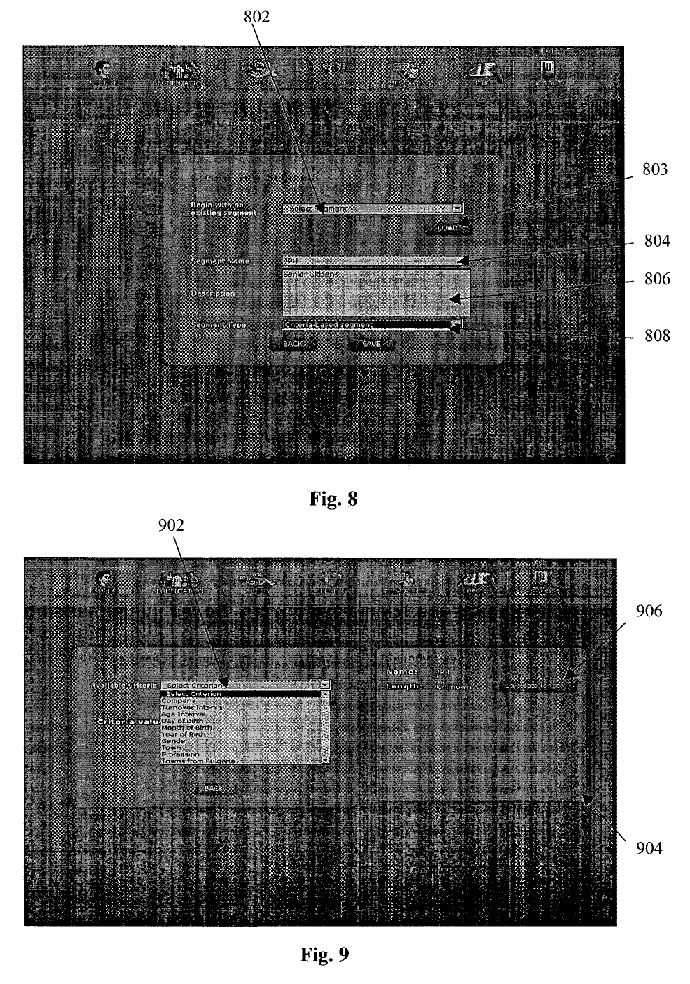

New market segments may be created by clicking on the button “CREATE NEW SEGMENT” 706. Clicking on this button produces the screen shown in FIG. 8. As shown, the administrator can use an existing segment (802) to base the new segment on, and load it using button 803. Areas are provided to enter a name 804 and description 806 of the new segment. Under segment type 808, the administrator can select whether the segment will be criteria based or whether the segment will be based on a list produced by third party software of, for example, the provider. Such a list may be imported into the DPS system. FIGS. 9-11, however, depict the selection of criteria for creating the new segment. Upon selecting the segment type as criteria based, the administrator may select the save button in FIG. 8, which produces the screen shown in FIG. 9. There, a list 902 of available criteria to be applied to the customer database of the telecom provider for creating the segment. As shown, such criteria may include company, turnover interval, age interval, date of birth, month of birth, year of birth, gender, town, profession, towns from Bulgaria and the like. Any one or more possible criteria may be selected for the segment—including other such criteria including: high school, university, professional school, number of children, color of eyes, height, weight, hair color, and the like. Such criteria is only limited by the imagination of the telecom provider, and/or the provider of the DPS system. One of skill in the art will appreciate that new criteria may be added, edited or deleted from time to time.

As also shown in FIG. 9, a “segment summary” window 904 shows the current summary of the segment. A calculate length button 906, allows the administrator to perform a check on the database of the number of account hits the current selected criteria will produce.

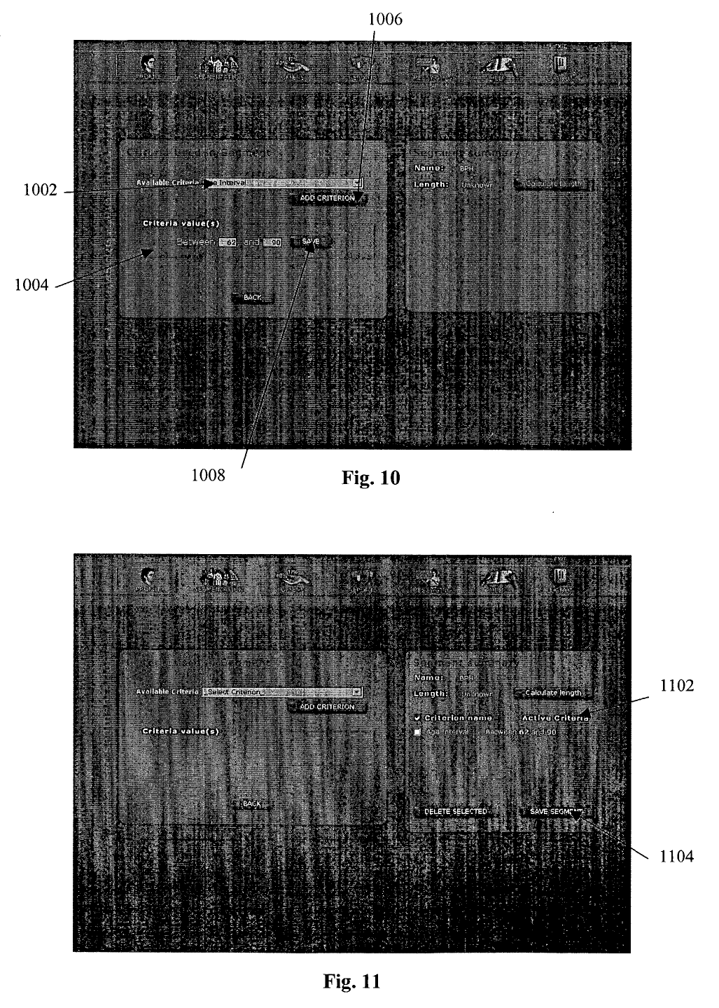

FIG. 10 illustrates the input of criteria values. In this example, the criteria selected is “age interval” 1002. The criteria values input area 1004 is displayed upon the criteria being selected, and the administrator clicking on the button Add Criteria 1006. Upon input of the criteria values, they are saved by clicking on the “Save” button 1008. Thus, after entering the criteria values and saving the criteria, it is displayed in the Segment Summary window 1102 as shown in FIG. 11.

Once the administrator has finished entering criteria for the new segment, the segment may then be saved by clicking on the “Save Segment” button 1104. The new segment will then be available in the segment list in the opening screen of “Segmentation”.

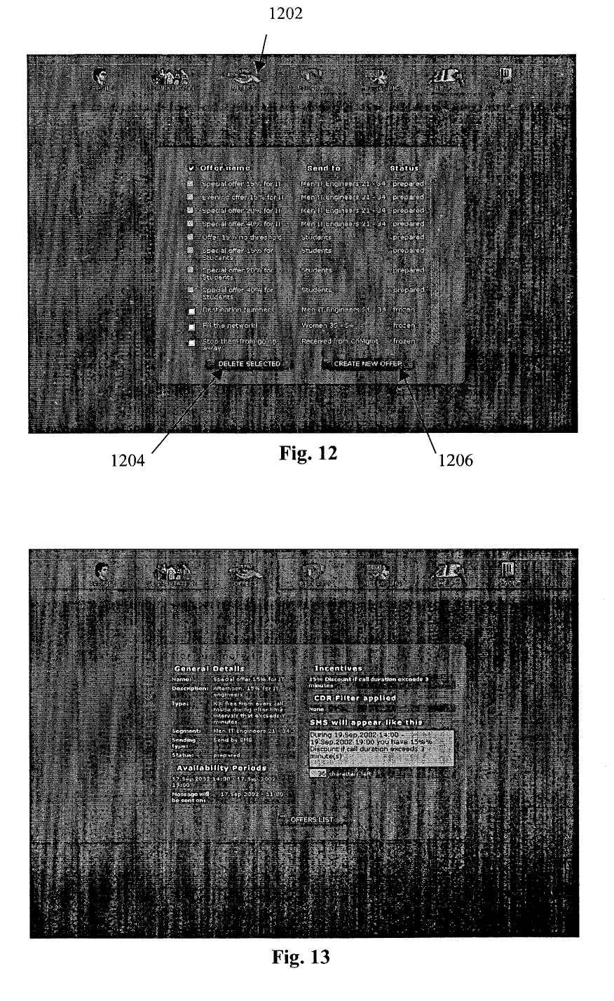

Offers are created by selecting the “Offers” icon 1202 as shown in FIG. 12. This displays a list of previous offers and the segments to which they apply, as well as their associated status. The details of these offers may be displayed by clicking on the offer. The details of one such previous offer is displayed in FIG. 13. A “Prepared” status indicates that the offer is ready and may be used. A “Frozen” status may be used for draft offers requiring, for example, further review.

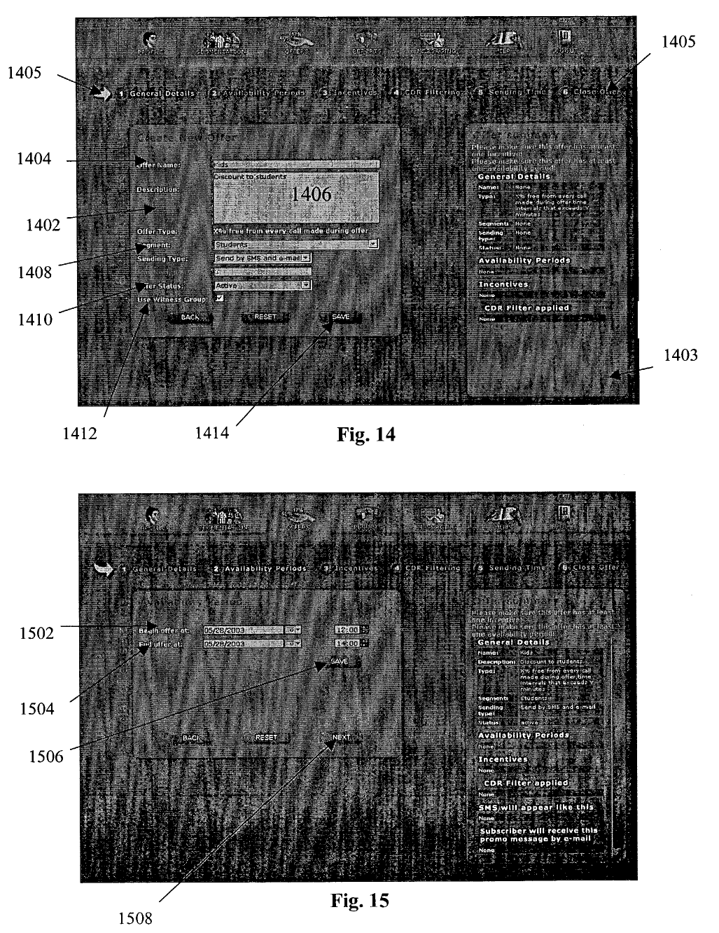

As shown, offers may be deleted (1204) and offers may be created (1206). FIGS. 14-23 illustrate various screens used to create an offer. Accordingly, as shown in FIG. 14, a create new offer window 1402 is displayed, where input areas are provided for the name 1404 of the new offer and the description 1406 of the offer. An “Offer Summary” window 1403 may be displayed for illustrating the current summary of the offer being created. In addition, the steps of the offer creation are provided in area 1405, which illustrates a highlight indicator (for example) for illustrating the current location of the offer creation process.

One of the segments may be selected via pull down menu 1408 for the offer to be sent to. As shown, in the present exemplary embodiment the offer type may be a percentage (“X%”) of every call made during the offer. However, this is only one such possible offer type, as other possible types may include: loyalty points, cash back, merchandise, airline miles, and the like.

The status of the offer may also be selected 1410 (e.g., frozen/active), and a “Witness Group” 1412 may be selected. The witness group, as explained earlier, allows the customer accounts selected in by the segment to be divided into, for example, two groups (e.g., equal groups). Only one group is sent the promotion. This is used to collect data for both groups and make a comparison to make a determination on the elasticity of the demand (see below).

After the general details of the offer have been input, the administrator may save the offer by clicking on the “Save” button 1414. Otherwise, the general details may be reset and new information input. After the general details have been saved.

The availability period may be established as shown in FIG. 15. As shown, begin and end times (date, which may include time of day), 1502 and 1504, respectively, are included which allow the administrator to specify the offer period. Clicking on “Save” 1506, saves the offer period, and may allow the administrator to enter another offer period. One the offer period(s) have been established, the administrator may click on “Next” 1508 to move onto the incentive definition. FIG. 16 illustrates a saved offer period.

FIG. 17 illustrates the screen used to specify the incentive type. In the case of the exemplary embodiment of X% off, the administrator may select a predetermined incentive level 1702. In the present example, the discount is from 5% to 100%, in intervals of 5%. The administrator may also specify the minimum call duration 1704 for the incentive to apply. Once the incentive level has been specified, the administrator clicks on “Next”.

FIGS. 18-20 illustrate the specification of the Call-Data-Record filtering, which allows the incentive of the offer to be applied to a particular type of call using one or more “filters” to apply to CDRs of associated customer accounts. For example, this allows incentives to be offered to particular cell sites of the mobile network (calls within a geographic location—e.g., all students in New York located near Columbia University). Other call data record filters may include a cell phone type, a service modifier, a service code, a service type (e.g., data, voice, fax, GPWS, etc.), dialed digits, record type and record sub-type, for example. Other types of details of call data records may be applied in such a filter. If more than one filter is applied, logical connectors for the filter may be selected (and/or). In some embodiments of the present invention, however, the “And” connector may only be used.

A Define Filter window 1802 and a filter summary group window 1804 are provided, as well as the offer summary window 1806. A new filter group may be created by clicking on “New Group” 1808.

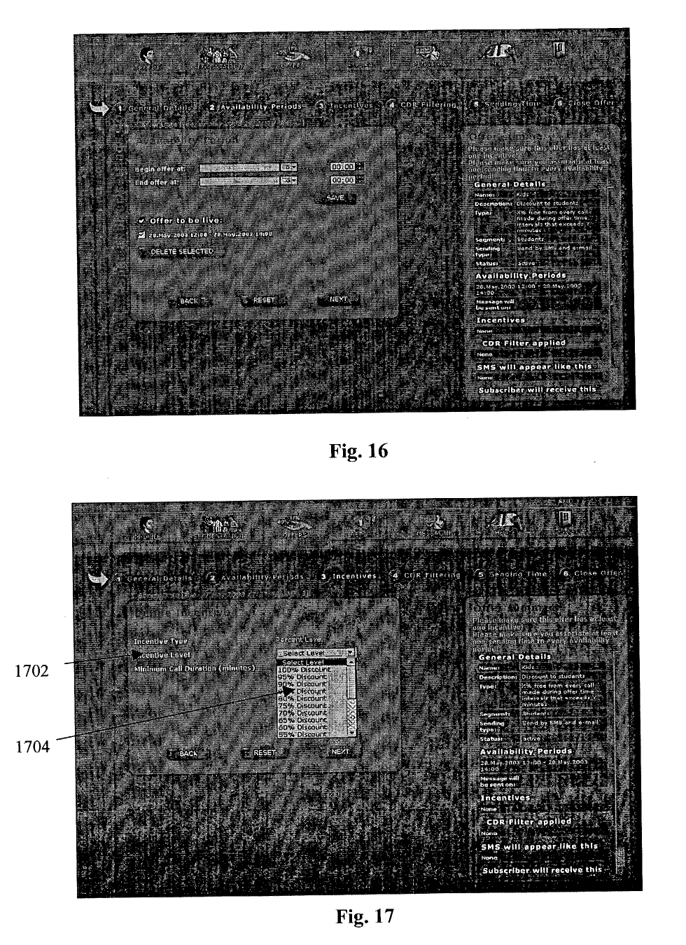

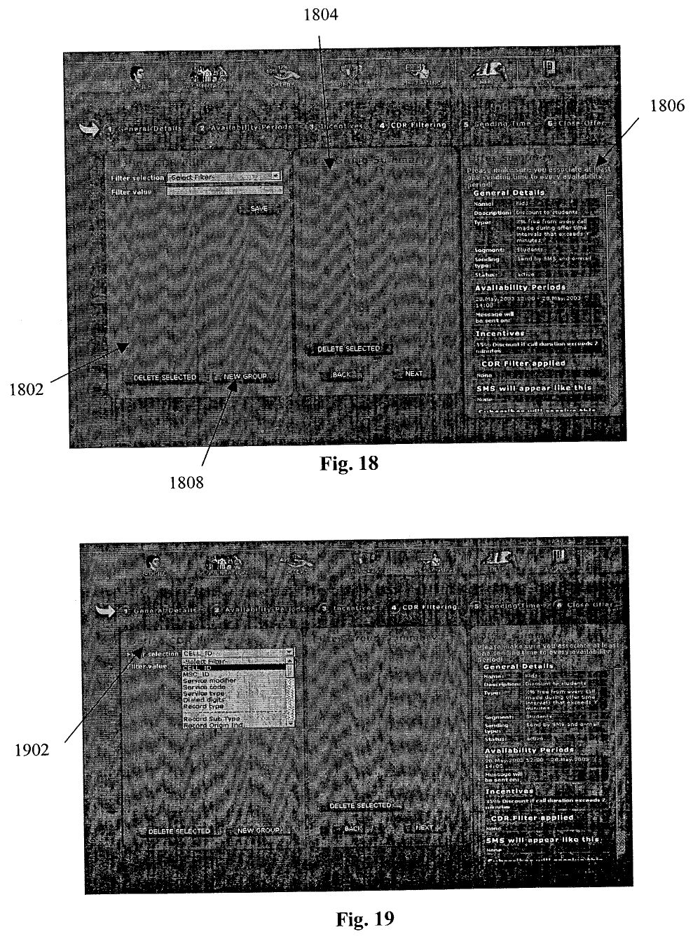

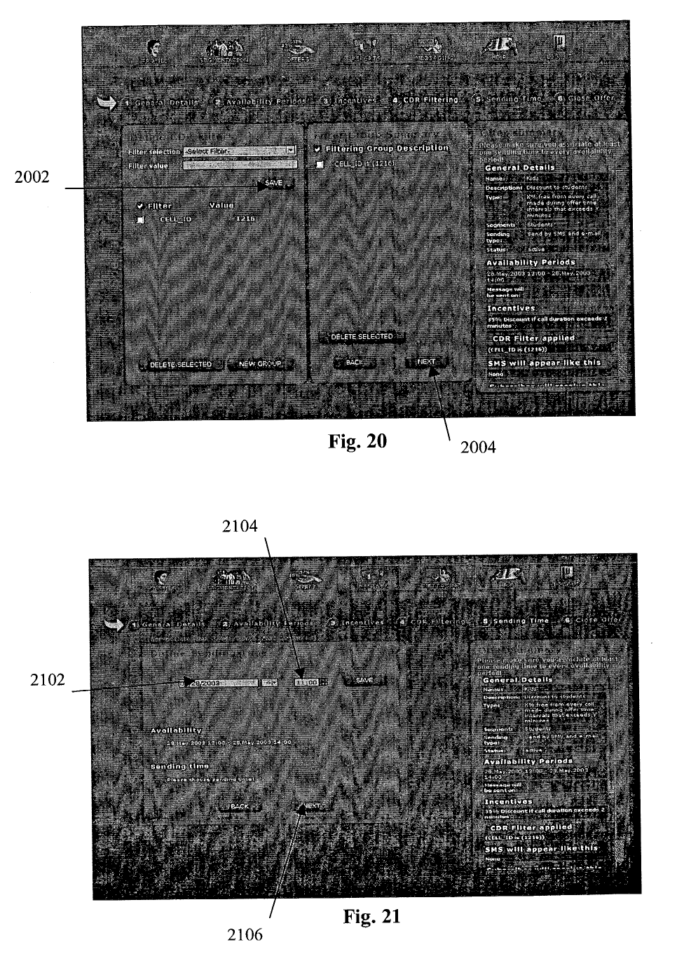

Upon a filter being selected from a filter selection pull-down menu 1902 (available filters), as shown in FIG. 19, a value may be added in the Filter value area 1904. Thus, if a “Cell ID” filter is selected, which is a filter associated with calls coming from predetermined cell sites, a value for the identification of an applicable cell site is input in the value area, for example. Clicking on “Save” 2002 (FIG. 20) saves the filter and value which may now be visible in all three display windows (or one or more, for example). When all the filters that an administrator desires to include in the present offer are selected, the administrator may select “Next” 2004 to move onto the next screen.

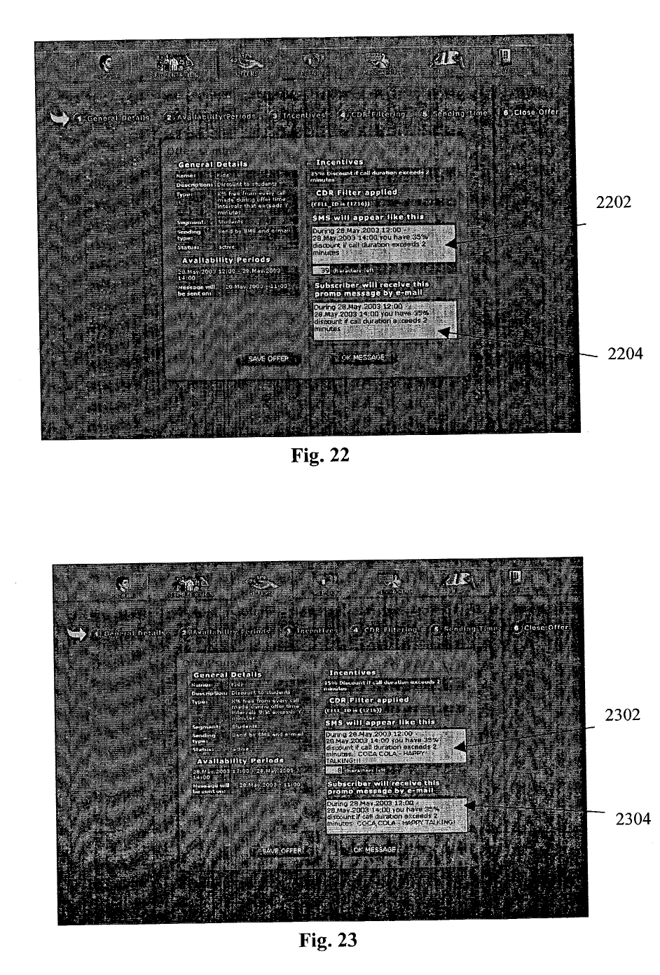

As shown in FIG. 21, a sending time for sending a message to the account holder of the customer account may be selected. As shown, a date 2102 and/or time 2104 may be selected for sending the message. Embodiments of the present invention may include logic to insure that the message can only be sent prior to the starting time of the offer. Moreover, other embodiments may include the ability for the setup of recurring offers and associated recurring notices to be sent to the account holders. Once the date/time for the notification has been selected it is saved (2106). Selecting “Next” directs the administrator to the Close Offer screen (FIG. 22).

The Close Offer screen illustrates the summary of the current offer, and the messages to be sent to the account holder, which may include an instant text message 2202 and/or email message 2204. One of ordinary skill in the art will recognize that recognizable speech depicting such messages may be computer generated and sent to the account holder via voice-mail or a direct call.

At this point, both messages may be edited. In some embodiments of the present invention, cross marketing may be established by inputting an advertiser in the text message. Accordingly, as shown in FIG. 23, the phrase “COCA COLA—Happy Talking!” may be added to either message 2302 and 2304. For such a service, the telecom provider may charge a fee. Thus, the cost of the promotion to the telecom provider may be off-set or transferred to the advertiser.

FIGS. 24-31 illustrate screen used to produce reports for all facets of the offers, including data reports on how effective the offers were (i.e., did a segment take advantage of an offer). Accordingly, upon selecting the “Reports” icon 2402 in the title bar, an introductory screen includes several buttons: General Reports 2404, Offer Report 2406, Segment Report 2408, Subscriber Report 2410 and Offer Elasticity Report 2412. These reports represent only some potential reports. Other reports typical of the telecom industry are within the scope of the embodiments of the present invention.

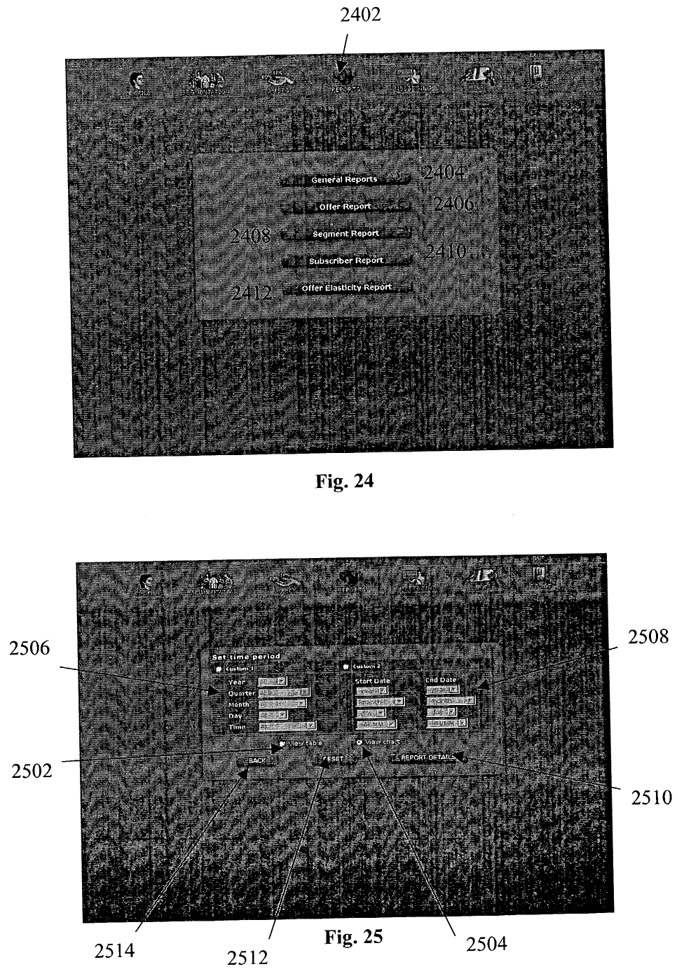

By selecting “General Reports”, the screen illustrated in FIG. 25 may be presented. Accordingly, this screen allows the administrator to select a table 2502 and/or chart 2504, of a set time period: custom 1 2506, for a particular year, quarter, month, day and/or time, or custom 2 2508, for a specific start and end date/time. Once this criteria has been selected, the table and/or chart may be displayed by selecting “Report Details” 2510. Otherwise, the information may be reset (2512), or the administrator may go back to the main report page (2514).

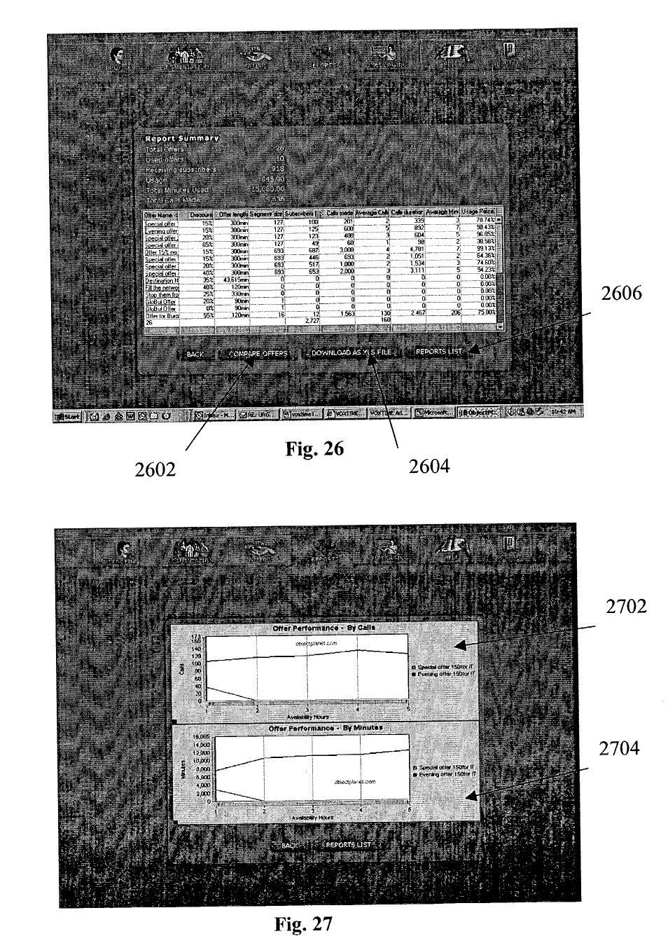

Selection of Report Details creates a table (if table view was selected) of the particulars of each offer that has been given, and may also present the associated details: name, discount, length of offer, segment size, subscribers to the offer, calls made, average call length, collective call duration, average minutes taken advantage of, usage of offer percent, etc.. A comparison may be made of the offers by selecting one or more offers and selecting the “Compare Offers” icon 2602 (FIG. 26). The table may also be downloaded in an XLS file, for example (2604). A “Reports List” button 2606 directs the administrator back to the main page. FIG. 28 illustrates a chart view of the first four offers in the Table of FIG. 26, viewed in minutes.

FIG. 27 illustrates a comparison of the first two offers listed in FIG. 26. The charts illustrate, for example, “Offer Performance” of the two offers in both Offer Performance by Calls 2702, and by Minutes 2704.

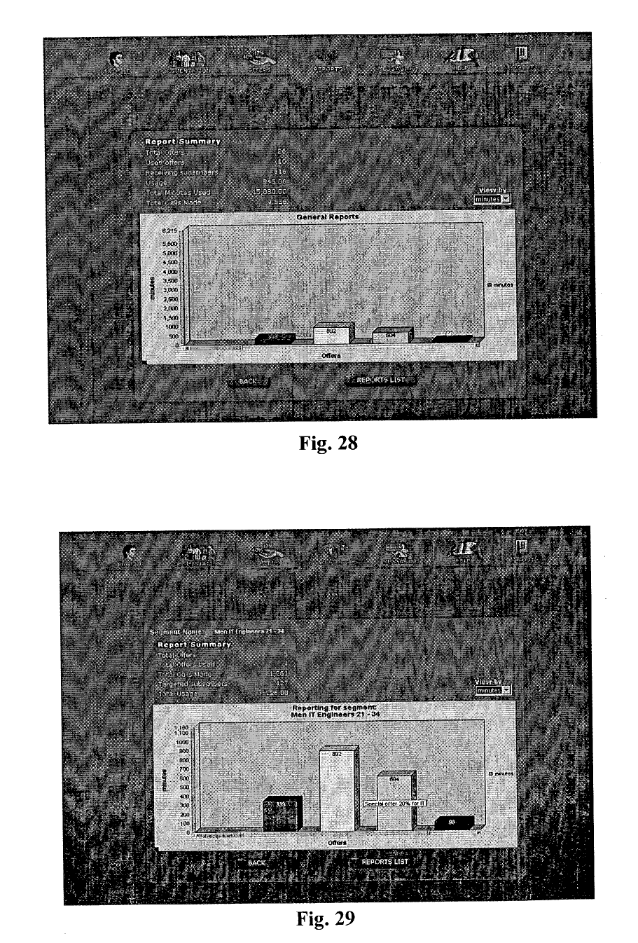

FIG. 29 illustrates a Segment report. The example illustrated is for an example segment of “Men IT Engineers 21-34”, viewed in chart form by minutes.

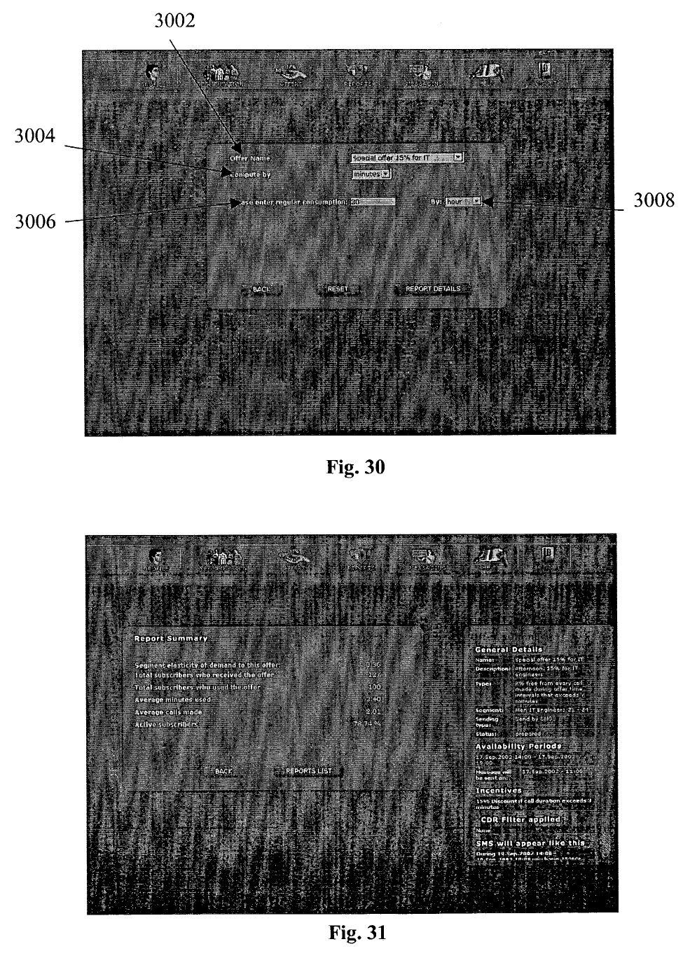

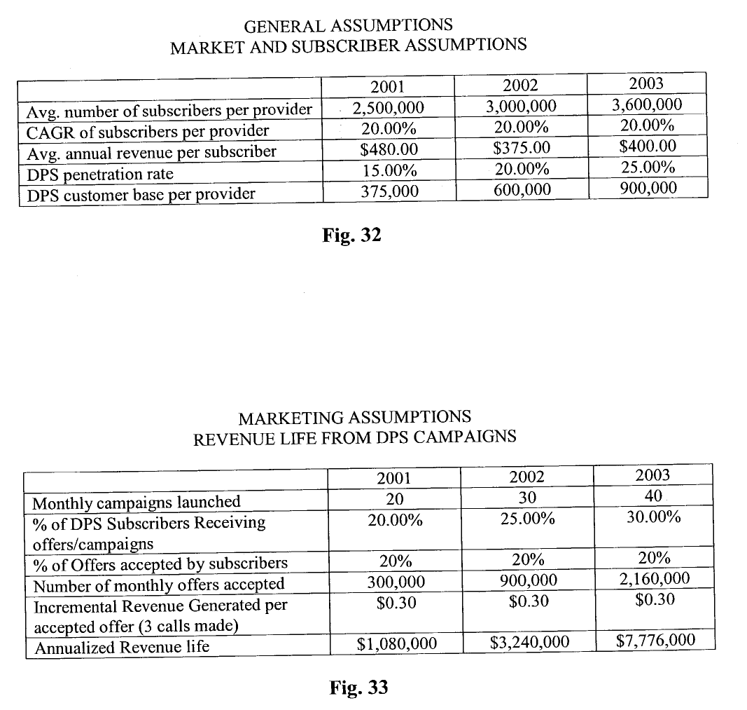

FIG. 30 illustrates a screen for producing an Elasticity Report (see “elasticity” above). Accordingly, pull down menu 3002 allows the administrator to select a particular offer, and compute the elasticity of demand report by minutes or calls (3004). If the segment to which the offer was applied did not have a witness group, then the administrator enters details about the regular consumption 3006 of that segment. For example, the number of minutes used per account holder for an hour, day, month, quarter, year, etc. (3008). Accordingly, the Elasticity Report is generated and illustrated in FIG. 31. Accordingly, the details of the report list may include the segment elasticity of demand to the offer, the total subscribers who received the offer, the total subscribers who used the offer, the average minutes used, the average calls made and the percentage of active subscribers who took advantage of the offer, and the like.

The segment elasticity of demand number is a number that is used to indicate whether the offer was well received by the segment (i.e., the promotion was a success e.g., the promotion generated account usage). In one embodiment of the present invention, if this number is greater than 1, it generally means that the offer was well received. An segment elasticity of demand number of 1 indicates that the offer was indifferent—some customers took advantage of the offer, but an equal number (for example), did not. If the elasticity of demand number is less than 1, the offer was not well received (e.g., the targeted segment did not take advantage of the offer).

Although particular embodiments have been disclosed herein in detail, this has been done by way of example for purposes of illustration only, and is not intended to be limiting with respect to the scope of the appended claims, which follow. In particular, it is contemplated by the inventors that various substitutions, alterations, and modifications may be made to the invention without departing from the spirit and scope of the invention as defined by the claims. Other aspects, advantages, and modifications are considered to be within the scope of the following claims.

What is claimed is:

1. A method for promoting usage of a customer account of a communications provider, the method comprising:
identifying one or more customer accounts of the communications provider for providing an incentive to an account holder of the one or more customer accounts to use the corresponding account;
determining an incentive for enticing the account holder of the customer account to use the account; and
notifying the account holder substantially in real-time of the incentive.

2. The method according to claim 1, wherein prior to identifying the one or more customer accounts, the method includes extracting customer information from a billing support system of a communications system.

3. The method according to claim 1, wherein the identified customer accounts comprise customer accounts substantially likely to be closed by the corresponding account holder.

4. The method according to claim 1, wherein the incentive is offered to the account holder via at least one of an email, a voice-mail, a phone call and/or instant messaging.

5. The method according to claim 1, wherein the incentive comprises at least one of a credit amount applied to the customer account, one or more loyalty points, cash, and/or a discount for a product and/or service.

6. The method according to claim 5, wherein the credit is forwarded to a billing support system of the communications system.

7. The method according to claim 6, wherein the credit is applied to the customer account immediately prior to an invoice being generated for the account holder.

8. The method according to claim 1, wherein the one or more customer accounts are selected based upon one or more predetermined criteria.

9. The method according to claim 8, wherein predetermined criteria comprise a personal and/or business details of account holders corresponding to the customer accounts and/or one or more aspects of one or more call data records of the one or more customer accounts.

10. The method according to claim 1, wherein the one or more customer accounts are selected based upon a personal profile of an account holder corresponding to the one or more customer accounts.

11. The method according to claim 1, wherein the one or more customer accounts are selected based upon one or more details of call data records of account holders corresponding to the customer accounts.

12. The method according to claim 11, wherein the call data records include one or more communication preferences of the account holders.

13. A method for promoting utilization of unused network capacity in a communications system comprising:
identifying a low usage period of network activity of a communications network;
identifying one or more customer accounts within the communications network for offering an incentive to a corresponding account holder of the one or more customer accounts to make use of the low activity period; and
notifying an account holder of the one or more customer accounts of the incentive substantially in real-time.

14. The method according to claim 14, wherein prior to identifying the one or more customer accounts, the method includes extracting customer information from a billing support system of a communications system.

15. The method according to claim 14, wherein the incentive comprises at least one of a credit amount applied to the customer account, one or more loyalty points, cash, and/or a discount for a product and/or service.

16. The method according to claim 16, wherein the credit is forwarded to a billing support system of the communications system.

17. The method according to claim 16, wherein the credit is applied to the customer account immediately prior to an invoice being generated for the account holder.

18. The method according to claim 16, wherein the credit is applicable only during the identified low activity period.

19. The method according to claim 14, wherein the one or more customer accounts are selected based upon one or more predetermined criteria.

20. The method according to claim 14, wherein predetermined criteria comprise a personal and/or business details of account holders corresponding to the customer accounts and/or one or more aspects of one or more call data records of the one or more customer accounts.

21. The method according to claim 14, wherein the one or more customer accounts are selected based upon details selected from call data records.

22. The method according to claim 21, wherein the call data records include one or more communication preferences of the customer accounts.

23. The method according to claim 14, wherein notifying comprises sending any one or more of an instant message, an email, a voice mail and a phone call.

24. The method according to claim 14, wherein the low usage period comprises a predetermined period of time.

25. A system for promoting usage of a customer account of a communications provider, the system comprising:
identifying means for one or more customer accounts of the communications provider for providing an incentive to a corresponding account holder of the one or more customer accounts;
determining means for determining an incentive for enticing the account holder of the customer account to use the account; and
notifying means for notifying the account holder substantially in real-time of the incentive.

26. A system for promoting utilization of unused network capacity in a communications system comprising:
first identifying means for identifying a low usage period of network activity of a communications network;
second identifying means for identifying one or more customer accounts of a communications provider who are located within the portion of the communications network experiencing the low usage; and
notifying means for notifying a corresponding account holder of the one or more customer accounts of an incentive to use the account substantially in real-time.

27. The system according to claim 26, wherein the first identifying means and the second identifying means comprise common identifying means.

28. A server in communications with a communications network, the server for promoting usage of one or more customer accounts of a communications provider, the server comprising:
one or more processors for identifying one or more customer accounts of the communications provider for providing an incentive to a corresponding account holder of the one or more customer accounts to use the account and for determining an incentive for enticing the account holder to use the account; and
communication means for notifying the account holder substantially in real-time of the incentive.

29. A system for promoting utilization of a communications system comprising:
a communications network;
a customer relations management system;
a billing support system (BSS) for managing billing to the one or more customers, the BSS including a customer database for storing customer information of the one or more customers, wherein the customer information includes call details of calls of the one or more customers;
a mediation system for collecting call detail information from the communications network, wherein the call detail information is forwarded to the BSS;
an incentive determining system including a lifestyle database, wherein the incentive determining system selects one or more customer accounts for receiving an incentive to a corresponding account holder of the one or more customer accounts for utilizing the account; and
an instant messaging service for notifying the selected one or more customers determined.

30. The system according to claim 29, wherein the incentive determining system determines which customer accounts receiving an incentive during a period of low-usage of the communications network.

31. A computer readable medium having computer instructions included thereon for enabling a computer system to perform a method for promoting usage of a customer account of a communications provider comprising:
identifying one or more customer accounts of the communications provider for providing an incentive to an account; holder of the one or more customer accounts to use the corresponding account;
determining an incentive for enticing the account holder of the customer account to use the account; and
notifying the account holder substantially in real-time of the incentive.

32. An application program being operable on a computer system to perform a method for a method for promoting usage of a customer account of a communications provider comprising:
identifying one or more customer accounts of the communications provider for providing an incentive to an account holder of the one or more customer accounts to use the corresponding account;
determining an incentive for enticing the account holder of the customer account to use the account; and
notifying the account holder substantially in real-time of the incentive.

33. A computer readable medium having computer instructions provided thereon for enabling a computer system of performing a method for promoting utilization of unused network capacity in a communications system, the method comprising:
identifying a low usage period of network activity of a communications network;
identifying one or more customer accounts within the communications network for offering an incentive to a corresponding account holder of the one or more customer accounts to make use of the low activity period; and
notifying an account holder of the one or more customer accounts of the incentive substantially in real-time.

34. An application program operable on a computer system for performing a method for promoting utilization of unused network capacity in a communications system, the method comprising:
identifying a low usage period of network activity of a communications network;
identifying one or more customer accounts within the communications network for offering an incentive to a corresponding account holder of the one or more customer accounts to make use of the low activity period; and
notifying an account holder of the one or more customer accounts of the incentive substantially in real-time.

35. A method for promoting utilization of a customer account of a communications provider comprising:
extracting customer information from a billing support system of a communications provider;
selecting one or more customer accounts for offering an incentive to a corresponding account holder of the one or more customer accounts to use the account, wherein the one or more customer accounts are selected based upon at least one of one or more personal details and one or more details obtained from call data records of the customer accounts, wherein the personal information is obtained from the customer information from the billing support system; and
notifying the respective account holders of the one or more customer accounts of the incentive substantially in real-time.

36. The method according to claim 35, further comprising identifying a period of low usage of the communications network, wherein the incentive is offered to the corresponding account holder of the one or more customer accounts during the low usage period.

37. A computer readable medium having computer instructions provided thereon for enabling a computer system to perform a method for promoting utilization of a customer account of a communications provider comprising:
extracting customer information from a billing support system of a communications provider;
selecting one or more customer accounts for offering an incentive to a corresponding account holder of the one or more customer accounts to use the account, wherein the one or more customer accounts are selected based upon at least one of one or more personal details and one or more details obtained from call data records of the customer accounts, wherein the personal information is obtained from the customer information from the billing support system; and
notifying the respective account holders of the one or more customer accounts of the incentive substantially in real-time.

38. An application program operable on a computer for performing a method for promoting utilization of a customer account of a communications provider comprising:
extracting customer information from a billing support system of a communications provider;
selecting one or more customer accounts for offering an incentive to a corresponding account holder of the one or more customer accounts to use the account, wherein the one or more customer accounts are selected based upon at least one of one or more personal details and one or more details obtained from call data records of the customer accounts, wherein the personal information is obtained from the customer information from the billing support system; and
notifying the respective account holders of the one or more customer accounts of the incentive substantially in real-time.
